(19) United States
(12) Patent Application Publication
(10) Pub. No.: US 2011/0050028 A1
(43) Pub. Date: Mar. 3, 2011

(54) ELECTRICAL MACHINE AND PROCESS FOR MANUFACTURING AN ELECTRICAL MACHINE

(76) Inventor: Bernd Ponick, Falkensee (DE)

(21) Appl. No.: 12/869,296

(22) Filed: Aug. 26, 2010

(30) Foreign Application Priority Data
Aug. 27, 2009 (DE) DE 102009038761.7

(51) Int. Cl. H02K 1/26

(52) U.S. Cl. 310/216.073; 310/216.112; 29/598

(57) ABSTRACT

The invention relates to an electrical machine with a stator (1) and a rotor (2), it being possible for the rotor (2) to be moved in rotary fashion with respect to the stator (1), and the stator (1) having slots (4), in which conductor loops (6) of a winding for electrically inducing a magnetic field are arranged, and the rotor (1) having slots (7), in which conductor loops (9) of a winding or cage bars (9) are arranged. Against this background, the invention specifies an electrical machine in which the disruptive noise emission can be reduced significantly whilst maintaining approximately the same performance data for the machine. For this purpose, provision is made for the slots (4, 7) of the stator and/or of the rotor to be spaced apart from one another nonuniformly over the circumference of the stator (1) or the rotor (2).

Furthermore the invention specifies a process for manufacturing such an electrical machine.

The invention relates to an electrical machine with a stator and a rotor in accordance with the precharacterizing clause of patent claim 1 and to a process for manufacturing such an electrical machine.

The invention relates in general to the field of elecromechanical energy conversion by means of electrical machines. Electrical machines are understood in this context to mean machines which implement a rotary movement or a translatory movement, for example electric motors and electric generators. In the field of the industrial generation of electrical energy and electrical drive technology, in over 95% of cases synchronous machines and induction machines (also referred to as asynchronous machines) are used. Such electrical machines are known, for example, from DE 10 2007 038527 A1 or EP 2 071 707 A1. The development and construction of electrical machines is generally performed with the aim of achieving the desired electromechanical energy conversion in a manner which is as efficient as possible. An electrical machine is developed, for example, in such a way that it emits the desired power at a desired rotation speed with a voltage and a frequency provided for said machine during operation without in the process being heated to an impermissible extent or being subject to excessive wear. In addition, it is a requirement of an electrical machine in practice to adhere to further conditions, such as a permissible noise emission and the provision of a certain torque quality, i.e. the avoidance of torque pulsations, for example. When designing an electrical machine and varying the design parameters, the developer is set certain boundaries since compliance with the primary target variables, such as output power of an electrical machine, should not be altered excessively in favor of a reduction in the noise emission.

Therefore, the invention is based on the object of specifying an electrical machine, in which the disruptive noise emission can be reduced significantly in the case of approximately constant performance data of the machine. In addition, the invention is based on the object of specifying a process for manufacturing such a machine.

This object is achieved by the electrical machine according to claim 1 and by the process specified in claim 7. The dependent claims give advantageous developments of the invention.

The invention has the advantage of indicating a possible way of efficiently reducing the noise emission by varying a specific design parameter of the electrical machine over the circumference of the stator or the rotor without notably impairing the performance data of the machine. It has been found that, by virtue of a nonuniform distribution of the gaps between the slots of the stator and/or the rotor, in particular a significant reduction in magnet noises of the electrical machine can be achieved.

A significant cause of the production of noises and torque pulsations comprises characteristic distortions of the magnetic field in the machine. By virtue of the magnetic field induced by the field winding of the electrical machine, magnetic forces are generated between the stator and the rotor. This results in radial forces between the stator and rotor which, inter alia, result in tensile stresses in the laminate stack of the stator. The tensile stresses are not equal in value in three dimensions over the circumference of the stator, but vary in three dimensions as a result of the discrete cogging in the stator and in the rotor. During operation of an electrical machine, in this case three-dimensional and temporally circumferential tensile stress waves are produced which result in a corresponding circumferential deformation of the stator laminate stack. In comparison with the dimensions of the electrical machine, the deformation is relatively small, but can result in an audible noise emission, in particular in the case of large machines, which is generally referred to as magnet noise.

A contributing factor to the production of magnet noises is so-called residual rotor fields, which are produced as follows. A cage winding is located in the rotor of induction and synchronous machines. The air gap field induced by the stator winding can, in accordance with the so-called rotating field theory, be considered to be a sum of rotating waves, which each have a characteristic harmonic number and characteristic frequency. Each of these rotating waves induces voltages in the mesh of the cage winding, which voltages in turn drive damping currents. These damping currents result in a return magnetic field on the stator which has, in addition to a rotating wave of the original harmonic number, additional harmonics which are referred to as residual rotor fields.

As a result of the nonuniform spacing of the slots of the stator and/or of the rotor according to the invention, the magnet noise can be considerably reduced by virtue of the tensile stress profiles not containing specific frequency components or these frequency components being at least considerably reduced. In this case, it is possible to take resonance effects into consideration as early as during the construction of the electrical machine, i.e. the variation of the gaps between the slots is determined in such a way that in particular those frequency components of the tensile stress waves which are in the region of the resonant frequencies of the electrical machine are reduced. As a result, for example, the gap between the slots can be varied in such a way that the individual frequency components of the resultant magnet noise are made more uniform in the sense of “white noise” and are therefore perceived as being less disruptive.

In principle, the invention can be used advantageously for all types of electrical machines which implement a rotary or tranlatory movement. It is merely necessary that a stator and a rotor are provided, with at least either the stator or the rotor needing to have slots for a winding or for electrical conductors. The invention can also be used advantageously for electrical machines in which both the stator and the rotor have slots. In this case, the teaching according to the invention relating to the nonuniform spacing of the slots can be applied to both the stator and the rotor. A particularly advantageous application area of the invention comprises induction machines and synchronous machines since the magnet noises have considerable relevance in practice in such machines.

In accordance with an advantageous development of the invention, the slots are arranged in accordance with a distribution scheme F(n). In this case, n is a sequential numbering of the slots i.e. an integer. The distribution scheme F(n) is determined in such a way that predetermined frequency components of the machine noise is reduced or does not occur. The aim is at least to reduce the amplitude of such frequency components in comparison with a conventional electrical machine, i.e. a machine which is not designed in accordance with the invention, or to completely avoid such frequency components. In particular, the intention is for excitation of such frequency components to be reduced as far as possible.

A particularly disruptive factor in magnet noises of electrical machines is perceived to be that dedicated individual tones are often produced which stand out against the overall noise of the machine to which air and bearing noises also contribute. As explained above, the cause of the magnet noises is that the magnetic field in the air gap of the machine exerts Maxwell interfacial forces on the stator and on the rotor which can deform, primarily, the stator. Particularly significant deformations and therefore the mentioned individual tones are produced if specific spectral components of the air gap field excite precisely specific parts of the machine, for example the stator, in the vicinity of a natural frequency. Advantageously, this can be avoided by determining a distribution scheme F(n) which is precisely determined in such a way that frequency components in the vicinity of natural frequencies are reduced or do not occur.

The distribution scheme F(n) can be established, for example, as a Table of the gaps between the slots depending on the slot number n, i.e. an indication of relative distances between respectively adjacent slots. It is also conceivable to specify the position of the slots in such a way that a slot n is assigned a mid position in the form of an angle indication φₙ in a polar coordinate system, which has its origin in the axis of rotation of the rotor. The distribution scheme F(n) can be determined by means of computer simulation as early as before the actual manufacture of the machine. In this case, a calculation of expected magnet noises is performed using a computer model of an electrical machine and then the distribution scheme F(n) is determined, for example by means of an iterative process, for example by automatically varying the gaps between the slots within the scope of the computer program until a minimum for the amplitude of the magnet noises is reached.

In accordance with advantageous developments of the invention, further design parameters of the electrical machine, in addition to the mentioned position of the slots or the slot pitch, can be nonuniform over the circumference of the electrical machine. This results in further parameters being available for optimizing the machine and minimizing the magnet noise. The inclusion of such further design parameters makes it possible to find suitable matching between these design parameters such that firstly, the magnet noise is reduced to as great an extent as possible, but secondly the nonuniform distribution of the design parameters does not have any noticeable effect of impairing the performance or efficiency of the machine.

As further design parameters, in particular the width of the teeth formed between the slots, the width of the slots themselves, the slot opening width and/or the depth of the slots can be nonuniform over the circumference of the stator or the rotor. Advantageously, these further parameters can be included in the distribution scheme F(n) such that the distribution scheme F(n) includes, for example in the form of a table, an assignment of the individual design parameters, namely gap between or angular position of the slots, the tooth width, the slot width, the slot opening width and the slot depth, to the respective slot number n.

An advantageous process for manufacturing an electrical machine of the type mentioned previously contains the following steps:
c) calculating a distribution scheme F(n) of the slots of the stator and/or of the rotor where n is a sequential numbering of the slots in such a way that predetermined frequency components of the machine noise is reduced or does not occur,
d) manufacturing the rotor and/or the stator in accordance with the results of the calculation from step c), and
e) manufacture of an electrical machine with a rotor and a stator in accordance with step d).

Advantageously, it is thus possible, even in an early phase of the manufacture of the electrical machine, namely when the slot distribution of the stator and of the rotor and possibly the other abovementioned design parameters are conceived, for a favorable influence on the magnet noises produced at the subsequent machine to be provided.

In accordance with an advantageous development of the invention, in step c), the calculation is performed by means of computer simulation of the electrical machine and an iterative determination of the distribution scheme F(n). The use of a computer simulation has the advantage that an electrical machine can be developed quickly and inexpensively, in particular without a large number of prototypes being constructed. In addition, the computer simulation makes it possible to include a high number of physical variables and design parameters of the electrical machine in a simple manner. Advantageously, in addition to the slot gaps, as further design parameters of the electrical machine it is possible to include the width of the teeth formed between the slots, the slot width, the slot opening width and/or the slot depth in the calculation of the distribution scheme F(n).

The invention will be explained in more detail below with reference to an exemplary embodiment using drawings, in which:

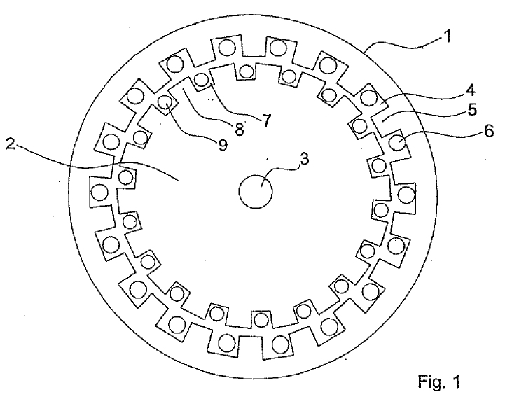

FIG. 1 shows a cross section through an induction machine, and

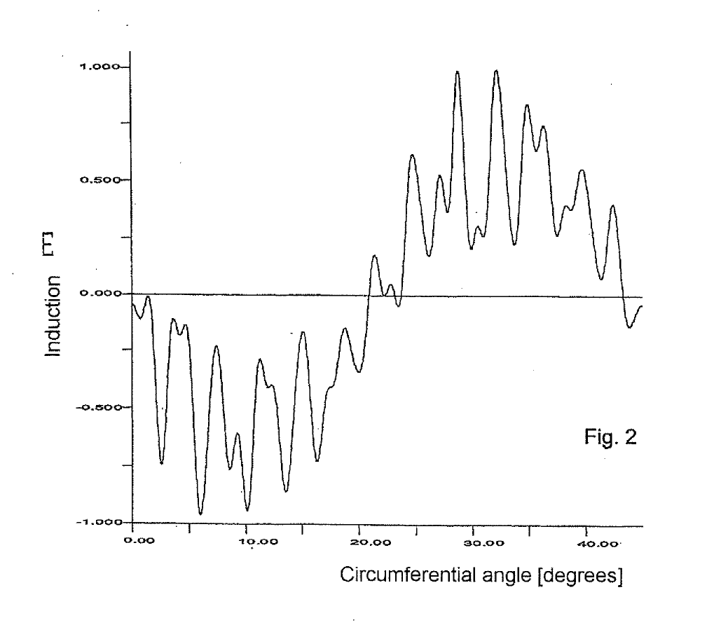

FIG. 2 shows an exemplary profile of the air gap induction over the circumference of an electrical machine and

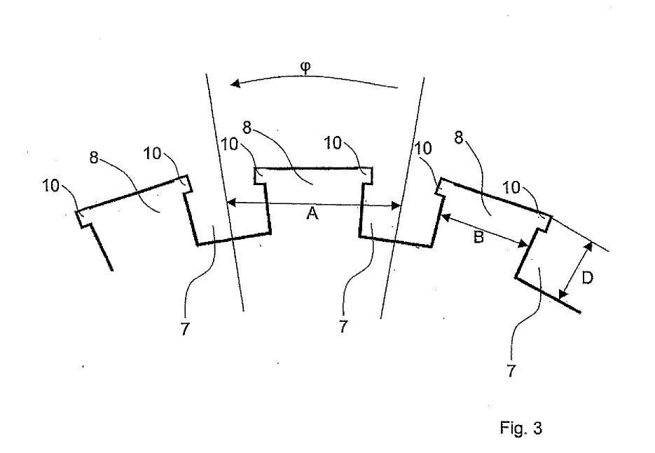

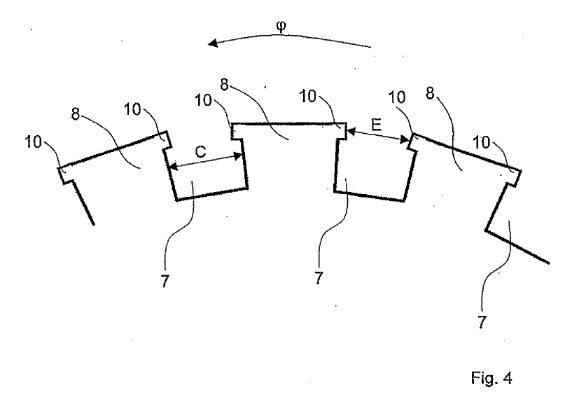

FIGS. 3 and 4 show a detail of the rotor of the electrical machine shown in FIG. 1 and

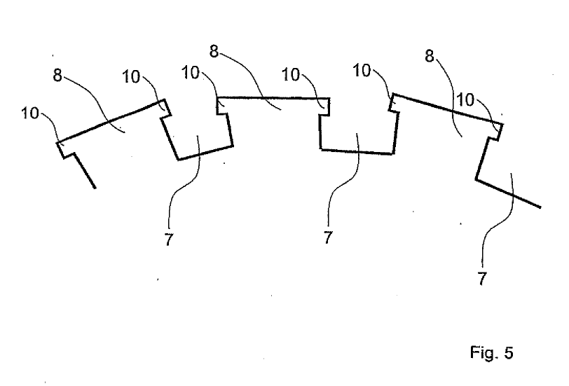

FIG. 5 shows a detail of a rotor with nonuniform design parameters.

The same reference symbols are used for mutually corresponding elements in the figures.

The electrical machine illustrated in FIG. 1 is in the form of an induction machine. The machine has a stator 1 and a rotor 2. The rotor 2 is capable of rotating about an axis 3. The stator 1 is designed to have a laminate stack, i.e. comprising thin iron laminates arranged next to one another in a row. The laminate stack has slots 4, between which teeth 5 are formed. Conductor loops 6 of a winding are arranged in the slots 4. The winding is used for inducing a magnetic field. The magnetic field is in the form of a circumferential rotating field, by virtue of which voltages are induced in a winding of the rotor 2. The voltages induce a rotor magnetic field, by means of which the rotor 2 is set in motion.

The rotor 2 for its part has slots 7 and teeth 8 formed between the slots. Conductor loops or bars 9 of a rotor winding are arranged in the rotor slots 7.

In FIG. 1, the conductor loops of the stator winding and of the rotor winding are symbolized by a single conductor. In practice, the winding comprises a large number of conductor loops which are arranged in the respective slots 4, 7, with the slots generally being as completely filled as possible by the conductor loops.

In the case of a squirrel-cage rotor, the conductor loops are in the form of individual squirrel cage bars 9.

FIG. 2 illustrates, by way of example, the profile of the induction in the air gap between the stator 1 and the rotor 2 over a circumferential range of 45° of the electrical machine. As can be seen, the induction and therefore the tensile stress brought about by the induction between the stator and the rotor have a profile which, in three dimensions, is not purely sinusoidal and therefore have a plurality of harmonics. The harmonics produced by the rotor winding are referred to as residual rotor fields and make a significant contribution to the production of magnet noises.

FIG. 3 shows a detail of the rotor 2 in an enlarged illustration. The figure shows three slots 7 and three teeth 8. FIG. 4 shows the same arrangement as in FIG. 3. FIGS. 3 and 4 serve to clarify the design parameters of the electrical machine. As can be seen from FIGS. 3 and 4, the teeth 8 have tooth tips 10 in the form of lateral protrusions. As a result of the tooth tips 10, the slots 7 are wider in the lower region than in the upper region of the teeth 8.

A first design parameter is the gap A between the slots 7. The gap A is understood to mean the gap between the mid points of the respective slots 7. The slot pitch can also be used as a first design parameter.

A further design parameter is the tooth width B, which is understood to be the gap between two adjacent tooth edges at half the tooth height.

A further design parameter is the slot width C which is understood to mean the gap between two adjacent slot edges at half the slot depth.

A further design parameter is the tooth height D.

A further design parameter is the width of the slot opening E, which is understood to mean the gap between two adjacent tooth tips 10 at half the tooth tip height.

According to the invention the mentioned design parameters A, B, C, D and E can be nonuniform over the circumference of the stator and/or of the rotor. FIG. 5 shows an example of a variation of the design parameters A, B, C, B and E over the circumferential angle φ.

1. Electrical asynchronous machine with a stator (1) and a rotor (2), it being possible for the rotor (2) to be moved in rotary fashion with respect to the stator (1), and
a) the stator (1) having slots (4), in which conductor loops (6) of a winding for electrically inducing a magnetic field are arranged, and
b) the rotor (1) having slots (7), in which conductor loops (9) of a winding or cage bars (9) are arranged, characterized in that
c) the gap between the mid points of the respective slots (7) or slot openings of the rotor is nonuniform over the circumference of the rotor (2).

2. Electrical machine according to claim 1, characterized in that the slot openings or slots (7) are arranged in accordance with a distribution scheme F(n), where n is a sequential numbering of the slots (7), and the distribution scheme is determined in such a way that at least one predetermined frequency component of the machine noise is reduced or does not occur.

3. Electrical machine according to claim 2, characterized in that the predetermined frequency component which is reduced or does not occur is in the region of a resonant frequency of the machine.

4. Electrical machine according to claim 1, characterized in that, in addition to the arrangement of the slot openings or slots (7), the distribution scheme F(n) contains, as further design parameters of the electrical machine, the width (B) of the teeth (8) formed between the slots (7), the slot width (C), the slot opening width (E) and/or the slot depth (D).

5. Electrical machine according to claim 1, characterized in that the width (B) of the teeth (8) formed between the slots (7) is nonuniform over the circumference of the rotor (2).

6. Electrical machine according to claim 1, characterized in that the width (C) of the slots (7) is nonuniform over the circumference of the rotor (2).

7. Electrical machine according to claim 1, characterized in that the depth (D) of the slots (7) is nonuniform over the circumference of the rotor (2).

8. Electrical machine according to claim 1, characterized in that the slot opening width (E) is nonuniform over the circumference of the rotor (2).

9. Process for manufacturing an electrical asynchronous machine, which has a stator (1) and a rotor (2), it being possible for the rotor (2) to be moved in rotary fashion with respect to the stator (1) and
a) the stator (1) having slots (4), in which conductor loops (6) of a winding for electrically inducing a magnetic field are arranged, and
b) the rotor (2) having slots (7), in which conductor loops (9) of a winding or cage bars (9) are arranged, comprising the following steps:
c) calculating a distribution scheme F(n) of the slot openings or the slots (7) of the rotor (2) where n is a sequential numbering of the slots (7) in such a way that at least one predetermined frequency component of the machine noise is reduced or does not occur, wherein the gap between the mid points of the respective slot opening or slots (7) of the rotor is nonuniform over the circumference of the rotor (2),
d) manufacturing the rotor (2) and/or the stator (1) in accordance with the results of the calculation from step c), and
e) manufacture of the electrical asynchronous machine with a rotor (2) and a stator (1) in accordance with step d).

10. Process according to claim 9, characterized in that, in step c), the calculation is performed by means of computer simulation of the electrical machine and an iterative determination of the distribution scheme F(n).

11. Process according to claim 9, characterized in that in addition to the position of the slot openings or slots (7), the distribution scheme F(n) contains, as further design parameters of the electrical machine, the width (B) of the teeth (8) formed between the slots (7), the slot width (C), the slot opening width (E) and/or the slot depth (D).

12. Process according to claim 9, characterized in that the predetermined frequency component which is reduced or does not occur is in the region of a resonant frequency of the machine.
